(19) United States
(12) Patent Application Publication
(10) Pub. No.: US 2009/0249059 A1
(43) Pub. Date: Oct. 1, 2009

(54) PACKET ENCRYPTION METHOD, PACKET DECRYPTION METHOD AND DECRYPTION DEVICE

(75) Inventor: Kazuya ASANO, Kawasaki (JP)

Correspondence Address: Fujitsu Patent Center;C/O CPA Global, P.O. Box 52050, Minneapolis, MN, 55402, US

(73) Assignee: FUJITSU MICROELECTRONICS LIMITED, Tokyo (JP)

(21) Appl. No.: 12/414,445

(22) Filed: Mar. 30, 2009

(30) Foreign Application Priority Data
Mar. 31, 2008 (JP) 2008-092786

(51) Int. Cl. H04L 29/06

(52) U.S. Cl. 713/150

(57) ABSTRACT

A packet encryption method for encrypting an IP packet communicated based on an internet protocol is provided. The packet encryption saves fragment information included in an IP header in an area other than the IP header, clears the fragment information included in the IP header, encrypts the IP packet in which the fragment information included in the IP header is cleared, and outputs the encrypted IP packet.

### CROSS-REFERENCE TO RELATED APPLICATIONS

This application claims the benefit of priority from Japanese Patent Application No. 2008-92786 filed on Mar. 31, 2008, the entire contents of which are incorporated herein by reference.

### BACKGROUND

1. Field

This application relates to a technique of processing a fragment in encrypting and transmitting an IP packet on a network.

2. Description of Related Art

Security Architecture for the Internet Protocol (hereinafter, referred to as the “IPsec”) is a method of encrypting data for communicating on the Internet.

The IPsec includes two types of encryption methods. In one method, encryption is performed between routers (VPN router) equipped with an IPsec function. In the other method, the encryption is performed between end terminals (PCs).

The IPsec has two types of encryption modes. One is a tunnel mode used in the VPN routers and the other is a transport mode used in the end terminals.

In the transport mode, authentication/encryption is performed only on a data portion of an IP packet, and an IP header is not encrypted. In the transport mode, encapsulation (an operation in which the IP header is regarded as a part of the data and a new IP header is attached) is not performed, thereby resulting in a low packet length overhead.

In the tunnel mode, the encryption and the encapsulation are performed over the IP header and a new IP header is attached to the packet that has been encrypted.

Techniques on IPsec processes are disclosed in Japanese Laid-open Patent Publication No. 2007-135035, Japanese Laid-open Patent Publication No. 2002-44135, and so on.

### SUMMARY

According to one aspect of an embodiment, a packet encryption method for encrypting an IP packet communicated based on an internet protocol is provided which saves fragment information included in an IP header in an area other than the IP header; clears the fragment information included in the IP header; encrypts the IP packet in which the fragment information included in the IP header is cleared; and outputs the encrypted IP packet.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an area in which a packet is protected;

FIG. 2 illustrates an exemplary IP packet before the IP packet is divided;

FIG. 3 illustrates examples of the divided IP packets;

FIG. 4 illustrates fragment information included in the divided packet;

FIG. 5 is a flowchart illustrating an IPsec encryption process;

FIG. 6 is a flowchart illustrating an IPsec decryption process;

FIG. 7 illustrates a format of a packet before encryption;

FIG. 8 illustrates a fragmentation process for an original packet;

FIG. 9 illustrates an IPsec process of a fragmented packet;

FIG. 10 illustrates an IPsec process of the original packet;

FIG. 11 illustrates a fragmentation process of an IPsec packet;

FIG. 12 illustrates a first embodiment;

FIG. 13 illustrates a second embodiment;

FIG. 14 illustrates an IPsec process of a fragmented packet in the second embodiment;

FIG. 15 illustrates the IPsec process of the fragmented packet in the second embodiment;

FIG. 16 illustrates an ESP format and an AH header format;

FIG. 17 illustrates an operation in an IPsec decryption process;

FIG. 18 illustrates a third embodiment;

FIG. 19 illustrates the third embodiment;

FIG. 20 illustrates an operation in an IPsec decryption process;

FIG. 21 illustrates a fourth embodiment;

FIG. 22 illustrates an operation in an IPsec decryption process; and

FIG. 23 illustrates a fifth embodiment.

### DESCRIPTION OF EMBODIMENTS

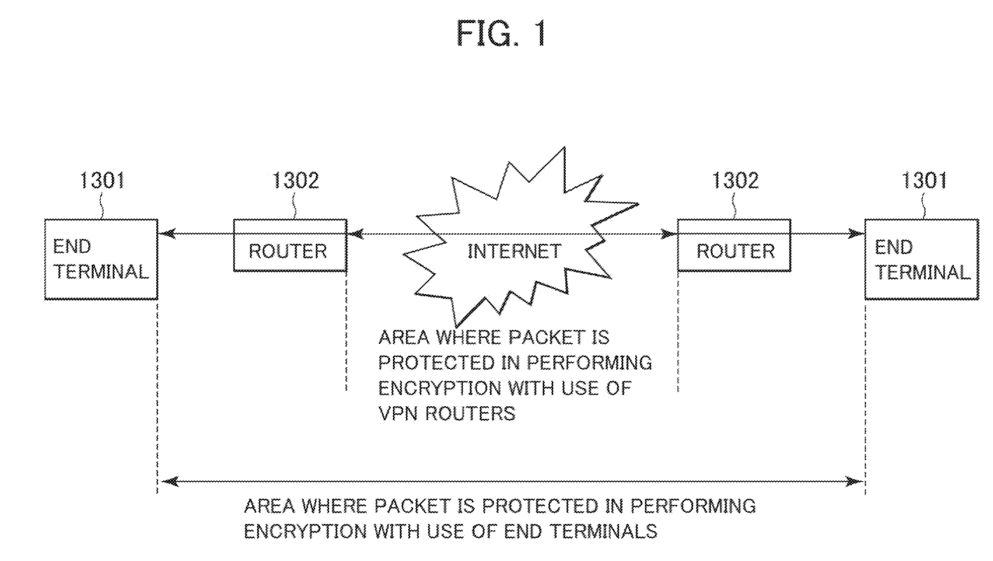

FIG. 1 illustrates an area in which a packet is protected (encrypted) when an IPsec process is performed between routers 1302 and an area in which the packet is protected (encrypted) when the IPsec process is performed between end terminals 1301. When the IPsec process is performed between the routers 1302, the routers perform an encryption/decryption process on the packet. When the IPsec is performed between the end terminals 1301, the end terminals perform the encryption/decryption process on the packet.

Generally, the upper limit on packet size on a network is approximately 1518 bytes and the lower limit is approximately 64 bytes. When a large amount of data that exceeds the upper limit is transmitted, the data may be divided into pieces. A process of dividing the IP packet into pieces is referred to as “fragmentation” and the divided packet is referred to as a “fragmented packet”.

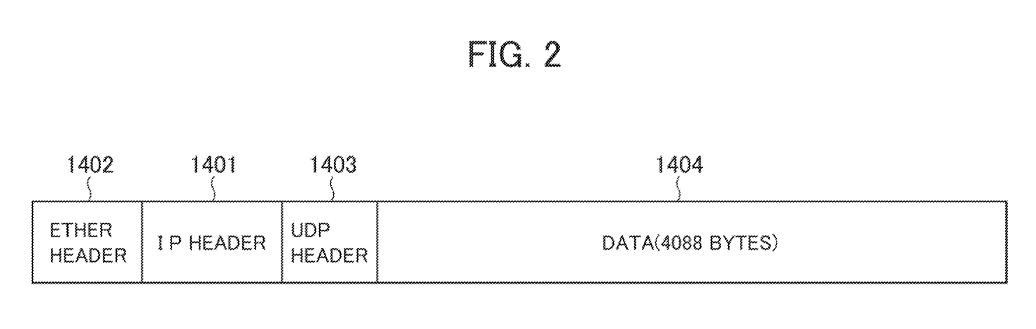

FIG. 2 illustrates an exemplary IP packet before the IP packet is divided into pieces.

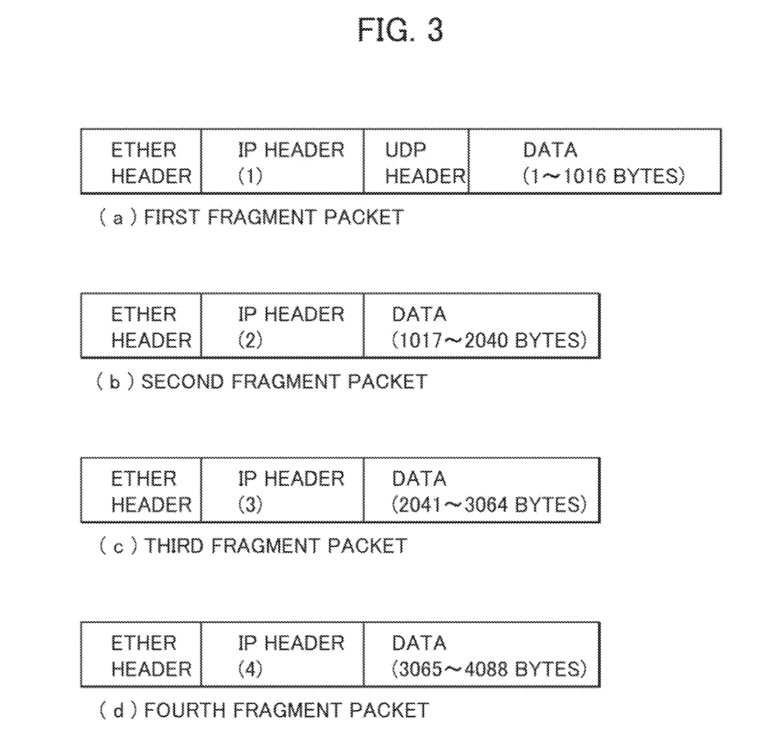

FIG. 3 illustrates examples of divided IP packets.

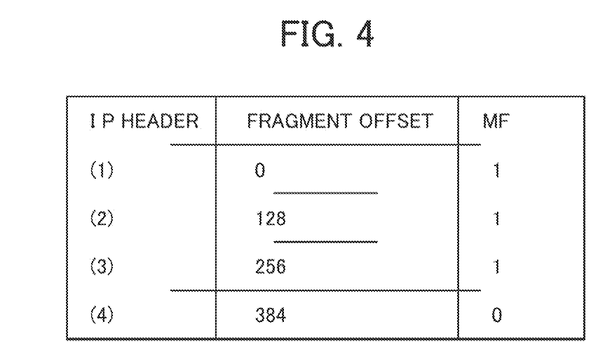

FIG. 4 illustrates pieces of fragment information included in the divided packet. The fragment information is represented by a fragment offset that indicates an offset from the head data in increment of 8 bytes and an MF (More Flag) that indicates whether there is a subsequent fragmented packet or not.

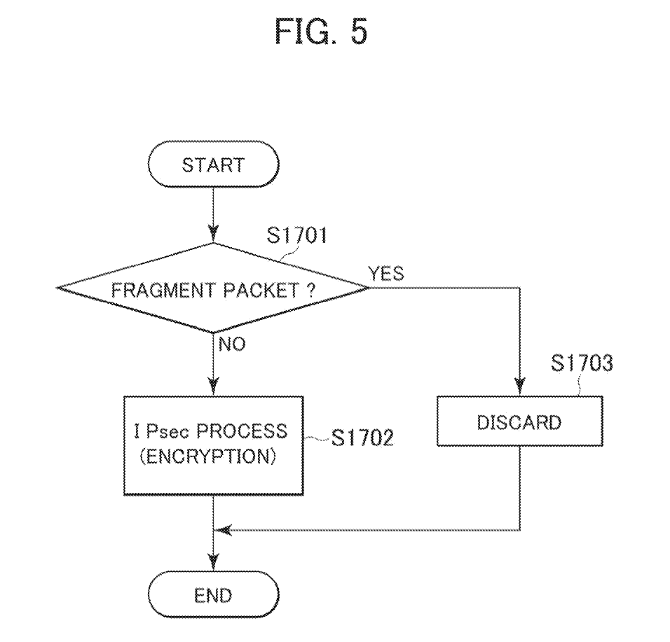

FIG. 5 is a flowchart illustrating an IPsec encryption process in the transport mode. An IPsec processing device monitors whether or not the fragmented packet has arrived (Operation S1701). If the fragmented packet has not arrived, the IPsec process (encryption) is performed (Operation S1702). If the fragmented packet has arrived, the arrived packet is discarded (Operation S1703).

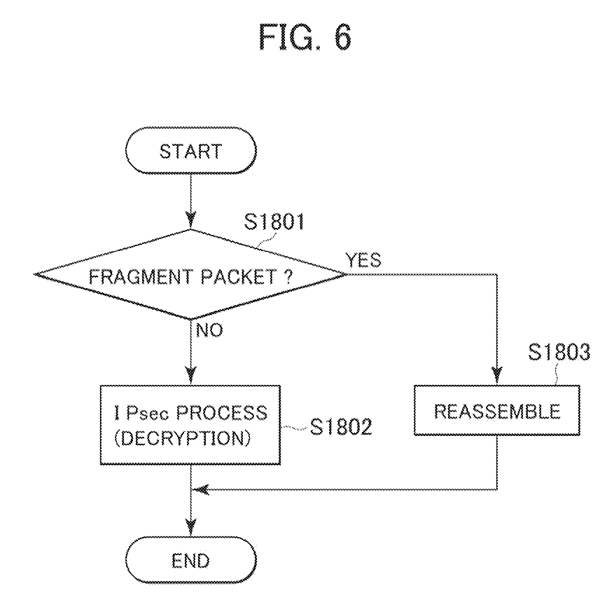

FIG. 6 is a flowchart illustrating an IPsec decryption process. The IPsec processing device monitors whether or not the fragmented packet has arrived (Operation S1801). If the fragmented packet has not arrived, an IPsec process (decryption) is performed (Operation S1802). If the fragmented packet has arrived, the IPsec processing device performs a reassembling process by which the fragmented packet is reassembled to the original IPsec packet (Operation S1803) and then performs the IPsec process (decryption) (Operation S1802).

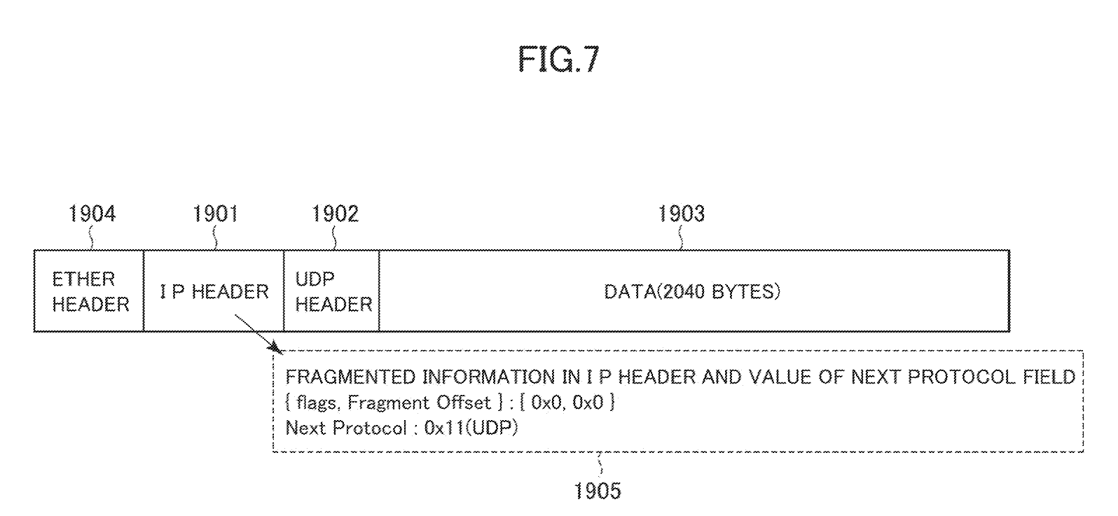

FIG. 7 illustrates a format of a packet before encryption.

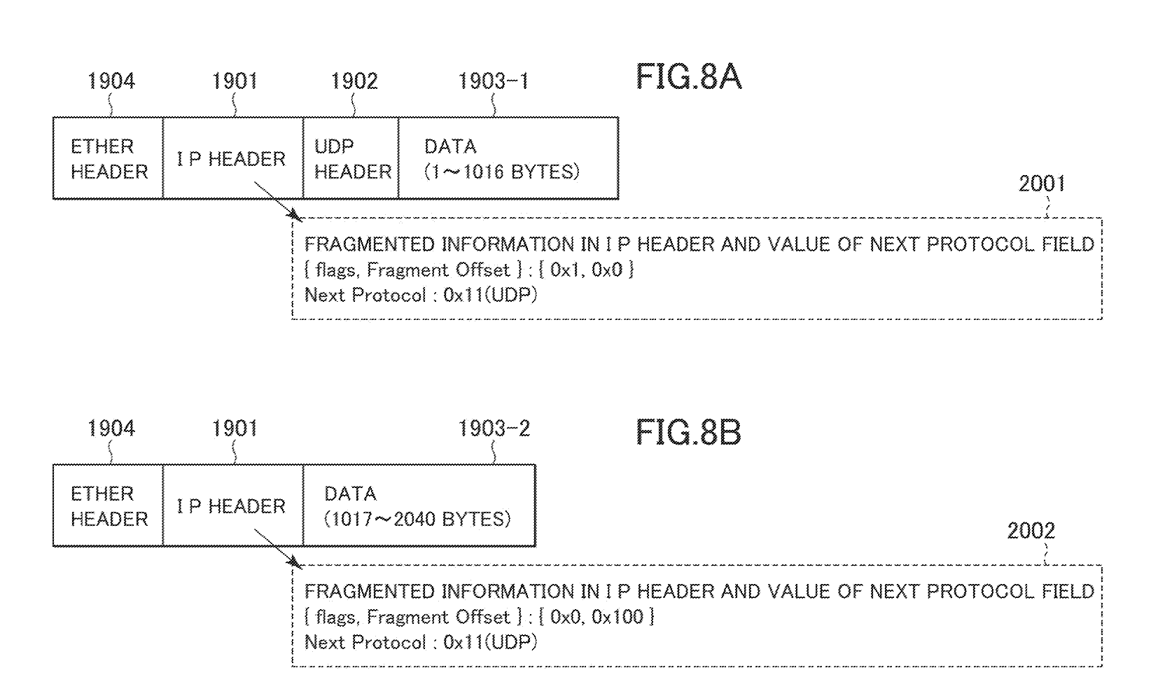

FIG. 8 illustrates a fragmentation process for the original packet. FIG. 8A illustrates a first fragmented packet and FIG. 8B illustrates a second fragmented packet.

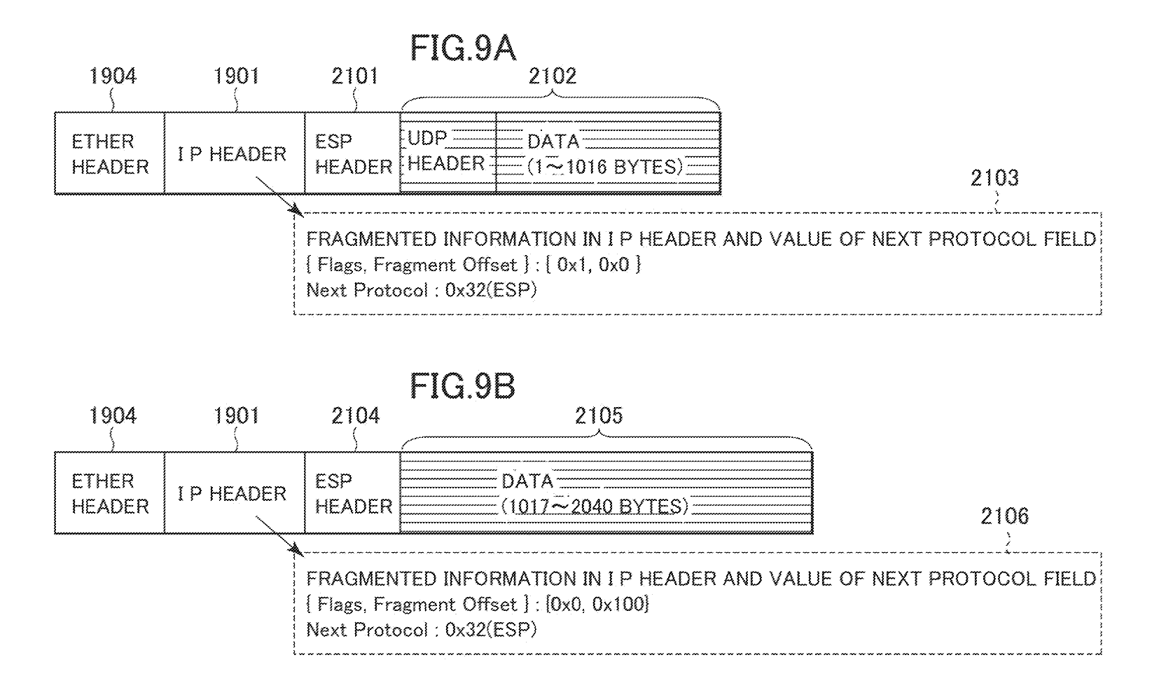

FIG. 9 illustrates an IPsec process for the fragmented packet. FIG. 9A illustrates a packet obtained performing the IPsec process on the first fragmented packet and FIG. 9B illustrates a packet obtained by performing the IPsec process on the second fragmented packet.

The packet obtained by performing the IPsec process on the packet illustrated in FIG. 9 is sent to a recipient.

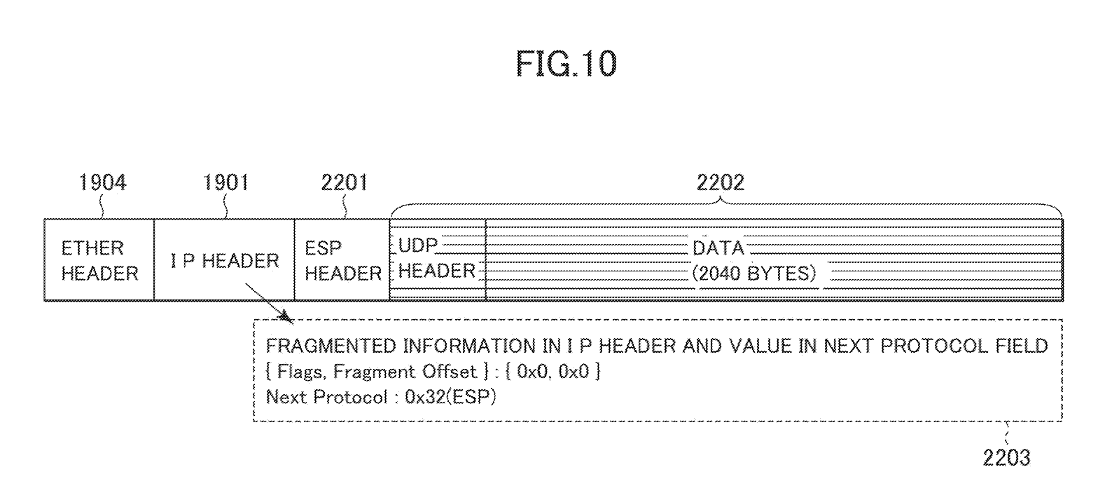

FIG. 10 illustrates the IPsec process for an original packet.

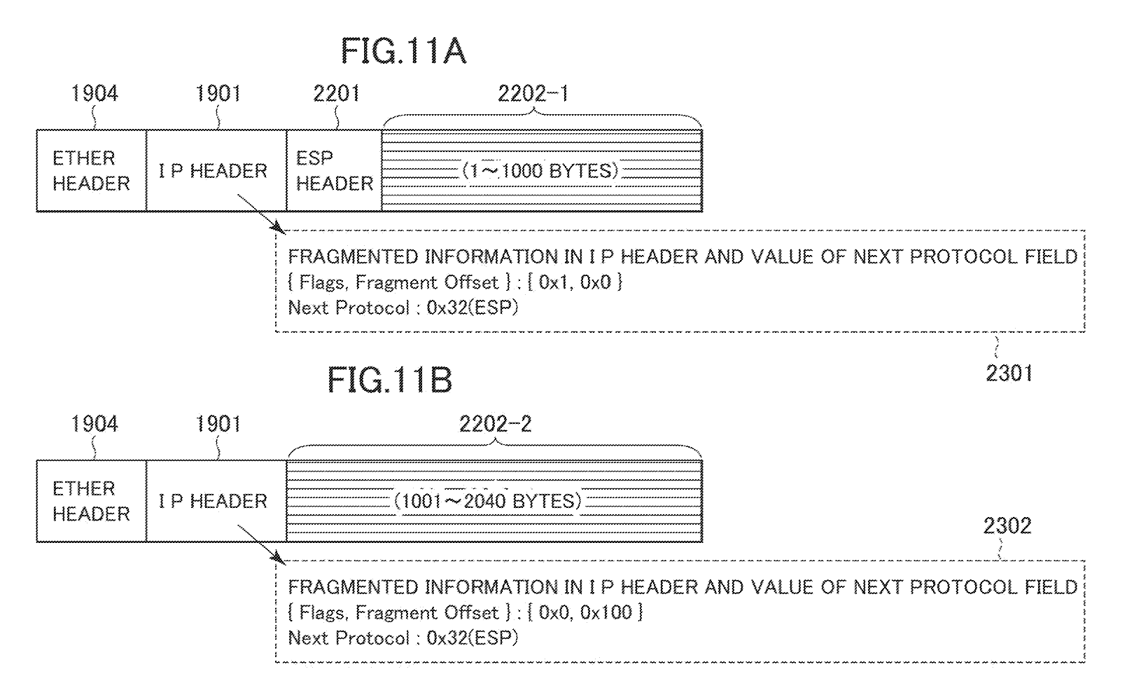

FIG. 11 illustrates a fragmentation process of the IPsec packet. FIG. 11A illustrates the first fragment packet obtained by performing the fragmentation process on the IPsec packet and FIG. 11B illustrates the second fragment packet obtained by performing the fragmentation process on the IPsec packet.

The packet obtained by performing the fragmentation process on the IPsec packet illustrated in FIG. 11 is sent to the recipient.

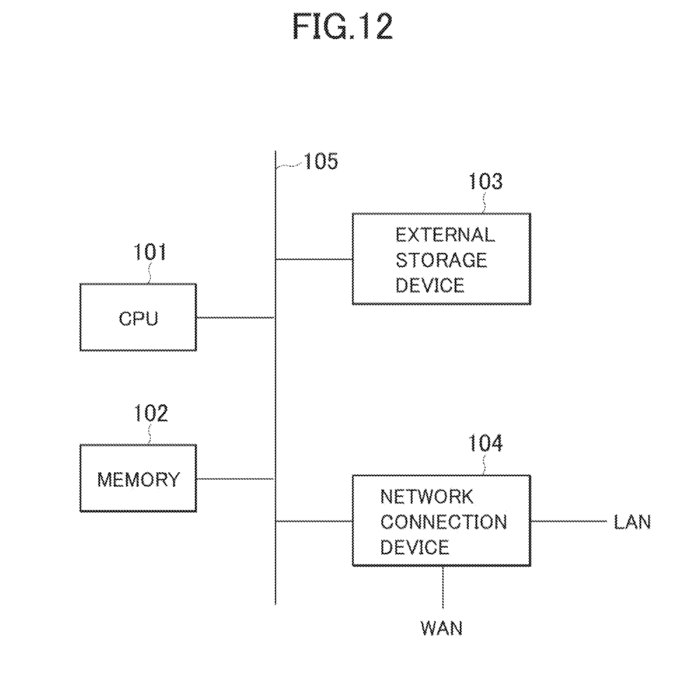

FIG. 12 illustrates a first embodiment.

A hardware configuration as illustrated in FIG. 12 may be a router device, a Bump In The Wire (BITW) device, a terminal device (workstation computer or personal computer), or the like.

A computer in FIG. 12 includes at least a CPU 101, a memory 102, an external storage device 103, and a network connection device 104, and the respective structural elements are coupled via a bus 105 with each other. If the hardware configuration corresponds to the terminal device, the external storage device 103 may be, for example, a hard-disc storage device or a CD-ROM storage device. If the hardware configuration corresponds to the router device, the external storage device 103 may be, for example, a flash ROM memory. In the first case, an input device such as a keyboard or a mouse, or an output device such as a display or a printer, is further coupled thereto. It should be noted that FIG. 12 is one example and the invention is not limited to the computer disclosed in FIG. 12. In addition, the invention is not limited to the computer but may be applicable to a circuit that includes a hard-wired logic without the memory or the external storage device.

The CPU 101 controls the entire computer. The memory 102 may be, for example, a RAM and temporarily stores a program or data stored in the external storage device 103 upon execution of the program or upon updating the data. The CPU 101 reads the program onto the memory 102 and executes the program.

The external storage device 103 mainly stores a variety of data and/or programs.

The network connection device 104 establishes a communication channel, such as a Local Area Network (LAN) or a Wide Area Network (WAN). The terminal device includes at least one of a port for the LAN and a port of the WAN.

The CPU 101 executes a variety of programs disclosed in the embodiments. The programs may be delivered from, for example, the external storage device 103 or the like. Alternatively, the programs may be acquired from the network via the network connection device 104.

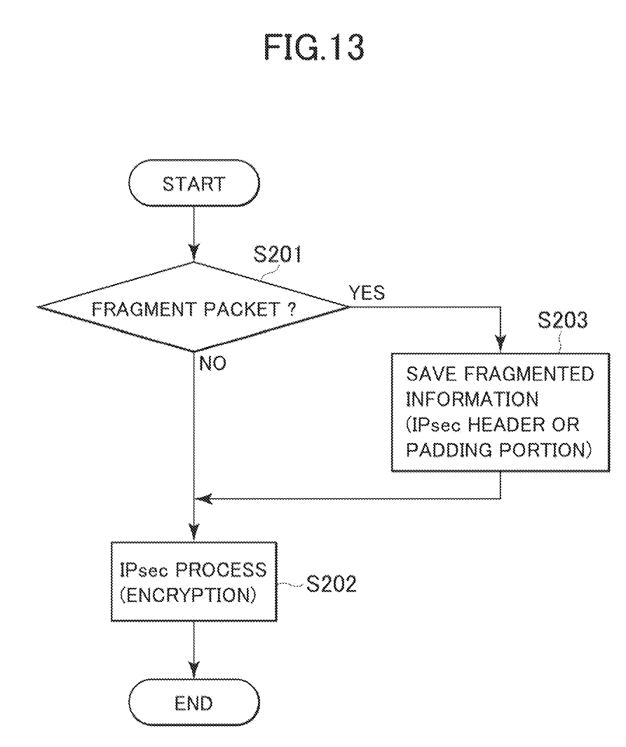

FIG. 13 illustrates a second embodiment. In the second embodiment, fragment information in a packet fragmented in advance is saved in an ESP header in an IPsec process. The fragment information in the packet fragmented in advance may also be saved in padding.

FIG. 13 is an operational flowchart of an IPsec encryption process performed by the computer (router device, BITW device, or terminal device) in FIG. 12. For example, it is determined whether or not a packet received from a LAN in FIG. 12 via a network connection device 104 is the fragmented packet (Operation S201). Whether or not the received packet is the fragmented packet is determined based on the fragment information in an IP header of the received packet.

If the received packet is not the fragmented packet, an ordinary IPsec process is performed (Operation S201 to Operation S202) and a generated IPsec packet is output to a WAN from the network connection device 104.

If the received packet is the fragmented packet, a fragment information saving process is performed (Operation S201 to Operation S203) and then the IPsec process is performed (Operation S203 to Operation S202).

For example, a fragmentation process is performed on a UDP packet illustrated in FIG. 7 in the hardware configuration (router device, BITW device, or terminal device) illustrated in FIG. 12.

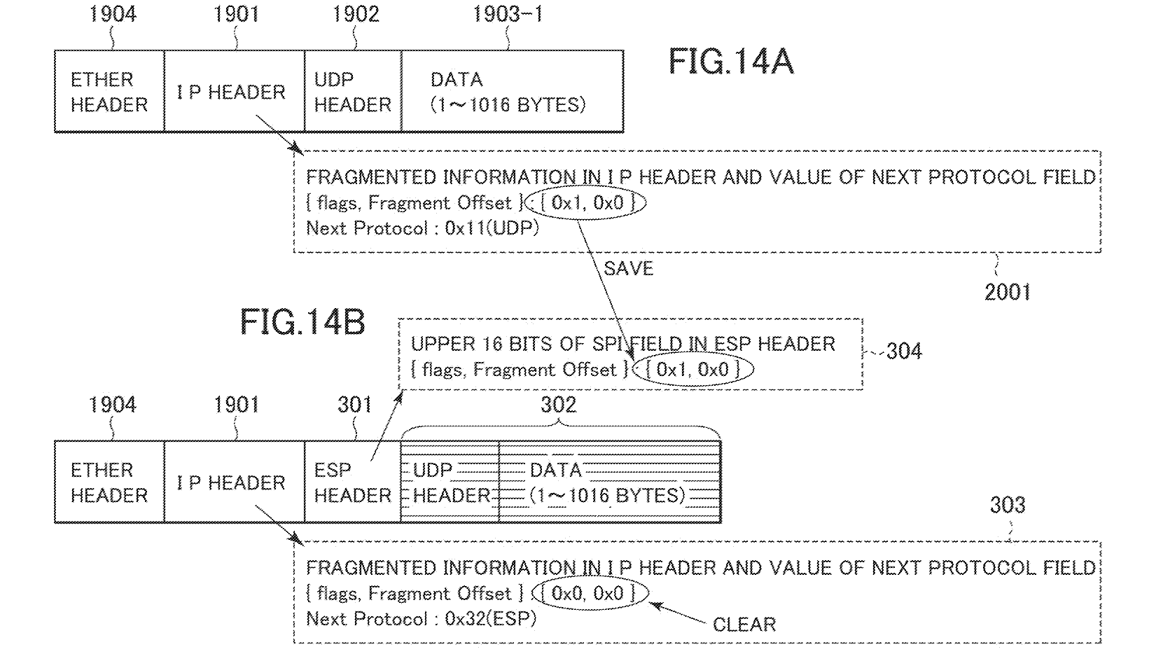

FIG. 14A illustrates a first fragmented packet before the IPsec process. As illustrated in a portion 2001 in FIG. 14A, the fragment information “{flags, Fragment Offset}” set in an IP header 1901 is “flag (MF)=1” (followed by subsequent fragments) and “Fragment Offset=0×0” (indicating a head fragment). A data portion of the packet includes a UDP header 1902 and data 1903-1 which stores the data from the first byte (head data) to the 1016th byte of data 1903 in an original packet.

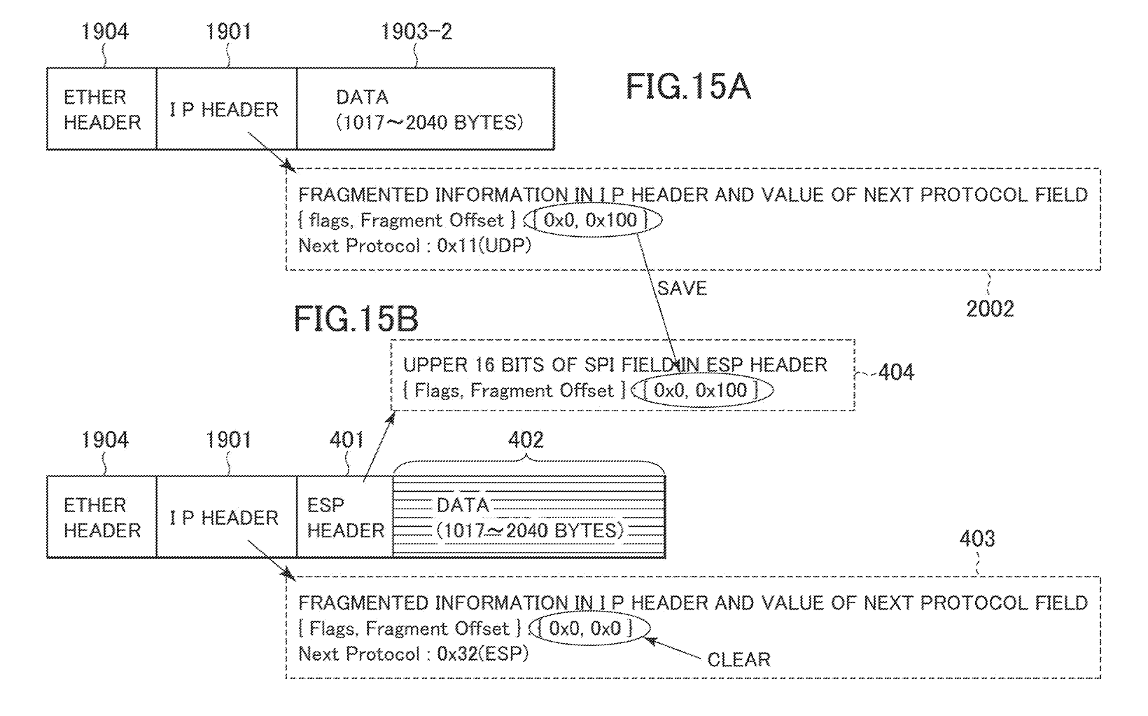

FIG. 14B illustrates a packet obtained by performing the IPsec process on the first fragmented packet illustrated in FIG. 14A. As illustrated in a portion 304 in FIG. 14B, the fragment information “{flags, Fragment Offset}, flag (MF)=1 and Fragment Offset=0×0” that has been set in the IP header 1901 in FIG. 14A is saved in upper 16 bits (lower 16 bits may also be possible) of an SPI field in an ESP header 301 attached to the IPsec packet. As illustrated in a portion 303 in FIG. 14B, the fragment information “{flags, Fragment Offset}” set in the IP header 1901 is cleared and becomes “flags (MF)=0 and Fragment Offset=0×0.” A value of a Next Protocol field in the IP header 1901 becomes a value “0×32” that indicates ESP encryption. The above description is a process in Operation S203 in FIG. 13. A data portion including the UDP header 1902 and divided data 1903-1 in FIG. 14A are encrypted and are stored in a data portion 302, and then the ESP header 301 is attached to the head of the data portion 302. The above description is a process in Operation S202 in FIG. 13. FIG. 15A illustrates a second fragmented packet before the IPsec process.

As illustrated in a portion 2002 in FIG. 15A, the fragment information {flags, Fragment Offset} set in the IP header 1901 becomes “flags (MF)=0 (no subsequent fragment)” and “Fragment Offset=0×100.” A data portion 1903-2 stores the 1017th byte to the 2040th byte of the data 1903 in the original packet.

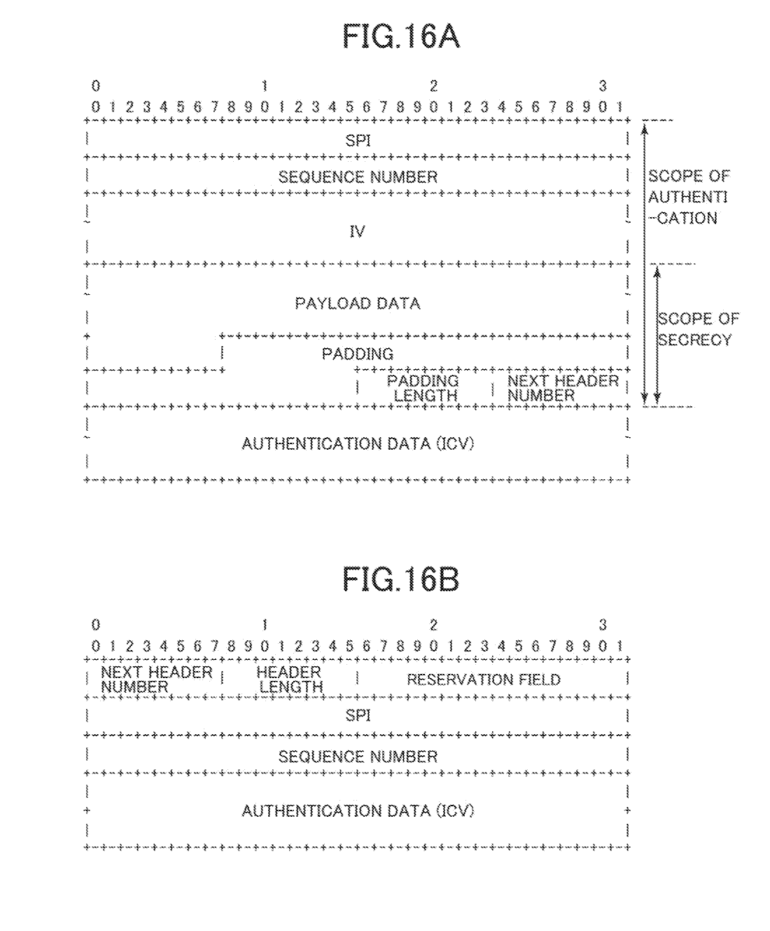

FIG. 15B illustrates a packet obtained by performing the IPsec process on the second fragmented packet illustrated in FIG. 15B. As illustrated in a portion 404 in FIG. 15A, the fragment information “{flags, Fragment Offset}, flags (MF)=0 and Fragment Offset=0×100” that has been set in the IP header 1901 in FIG. 15A is saved in upper 16 bits (lower 16 bits may also be possible) of an SPI field in an ESP header 401 attached to the IPsec packet. As illustrated in a portion 403 in FIG. 15B, the fragment information “{flags, Fragment Offset}” set in the IP header 1901 is cleared and becomes “flags (MF)=0 and Fragment Offset=0×0.” The value of the Next protocol field in the IP header 1901 becomes the value “0×32” that indicates the ESP encryption. The above description is the process of Operation S203 illustrated in FIG. 13. A data portion including the divided data 1903-2 in FIG. 15A is encrypted and is stored in a data portion 402, and then the ESP header 401 disclosed above is attached to the head of the data portion 402. The above description is the process in Operation S202 in FIG. 13. FIG. 16A illustrates an IP Encapsulating Security Payload (ESP) format. The ESP is included in a portion 301 and a portion 302 in FIG. 14 or a portion 401 and a portion 402 in FIG. 15. A “Security Pointer Index (SPI)” in FIG. 16A is a 32-bit integer value assigned in relation to an agreement (referred to as a “Security Association (SA)”) on an encryption algorithm and an encryption key. The agreement is about, for example, which encryption algorithm has been used in encrypting a transmission content in the packet or which encryption key is used. A decryption device on the recipient determines settings of the SPI in a negotiation in establishing communication and selects the encryption algorithm and the encryption key for the decryption based on the SPI once the communication has been established. In the second embodiment, the fragment information may be saved, for example, in the upper 16 bits (lower 16 bits may also be possible) of the SPI. Although the ESP format illustrated in FIG. 16A is defined in RFC4303 (IPsec version 3), the ESP format is applicable in RFC2406 (IPsec version 2).

In the second embodiment, the packet on which the fragmentation process has already been performed in advance undergoes the IPsec process (encryption). Since the fragment information of the IP header portion in the Ipsec-processed IPsec packet is cleared, the Ipsec-processed IPsec packet, as an apparently non-fragmented IPsec packet, is sent to the WAN or the like from the device in FIG. 12.

Then the IPsec packet thus sent may undergo the fragmentation. In the above case, a piece of new fragment information is set in the IP header of the IPsec packet.

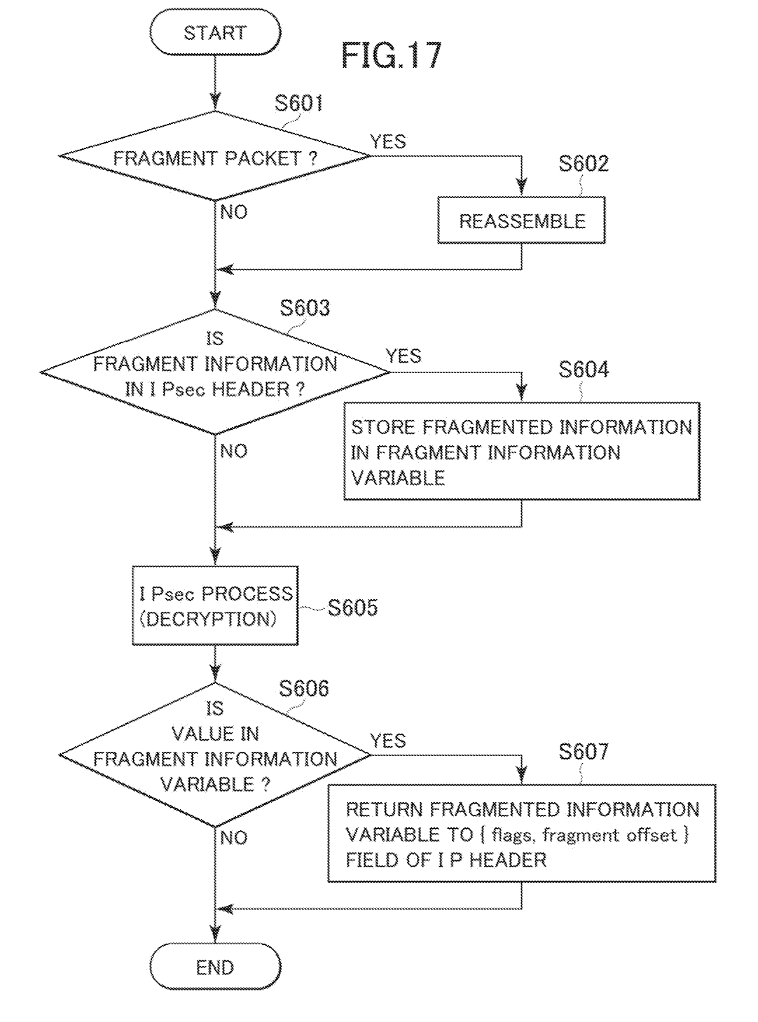

FIG. 17 illustrates an operational flowchart of an IPsec decryption process performed by the computer (router device, BITW device, or terminal device) in FIG. 12 in the second embodiment. For example, it may be determined whether the packet received via the network connection device 104 from the WAN in FIG. 12 is the fragmented packet or not (Operation S601).

If the received packet is the fragmented packet, the received packet is determined to be the packet on which a sender has performed the fragmentation process after the IPsec process, and a reassembling process for reassembling the original IP packet is performed (Operation S602).

If the received packet is not the fragmented packet, or subsequent to the reassembling process, it is determined whether or not the fragment information is stored in the upper 16 bits (lower 16 bits are also possible) in the SPI field of the ESP header which is the IPsec header (the portion 304 in FIG. 14B or the portion 404 in FIG. 15B) (Operation S603).

If the fragment information is stored, the fragment information is stored in a fragment information variable on the memory 102 in FIG. 12 (Operation S604).

If the fragment information is not stored or after the fragment information has been stored in the fragment information variable (in this case, the fragment information has been stored), the IPsec process (decryption) is performed and the original packet before the encryption is picked up (Operation S605).

It is determined whether or not the fragment information variable has a certain value (Operation S606). If the fragment information variable has a certain value, the decrypted packet is the fragmented packet. The value of the fragment information variable is returned to a fragment information field (see the portion 2001 in FIG. 14A or the portion 2002 in FIG. 15A) of the IP header in the decrypted packet.

The packet before the encryption obtained in the second embodiment is output from the network connection device 104 to the LAN illustrated in FIG. 12. If the output packet is the fragmented packet, the terminal device at a subsequent stage performs the reassembling process.

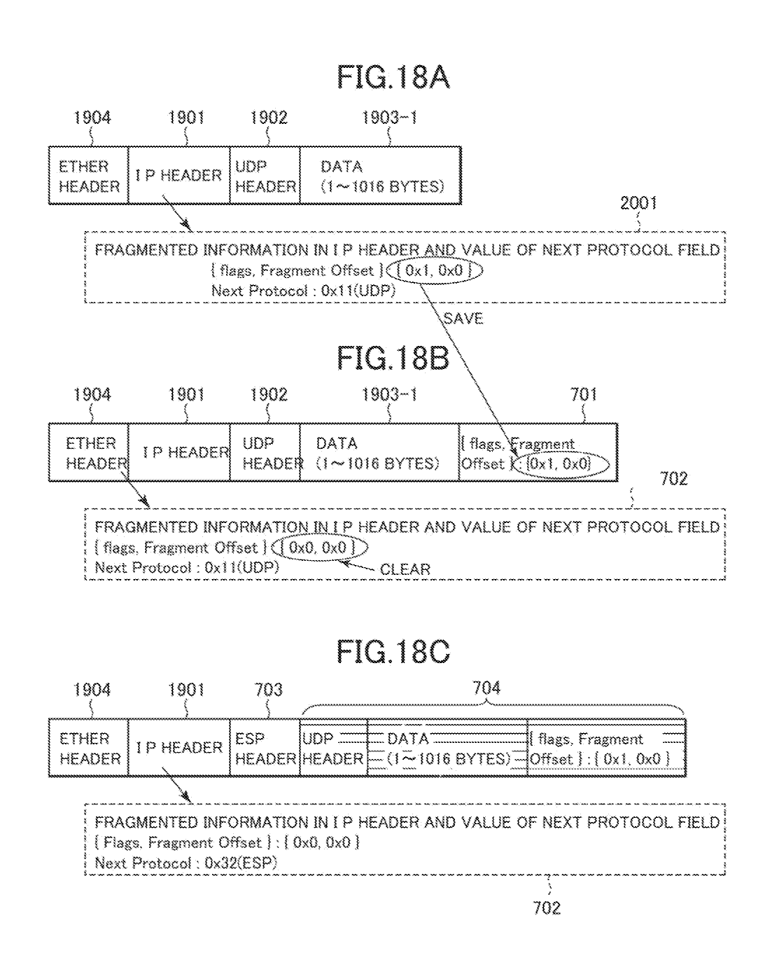

FIG. 18 illustrates a third embodiment. In the third embodiment, a piece of fragment information in a packet fragmented in advance is saved in padding in an IPsec process.

In the third embodiment, an operation of the IPsec encryption process performed by a computer (router device, BITW device, or terminal device) in FIG. 12 is the same as that of the IPsec encryption process in the second embodiment illustrated in FIG. 13.

The process that is different from the second embodiment is a fragment information saving process used where a received packet is the fragmented packet (Operation S203 in FIG. 13). In the second embodiment, the fragment information is saved in the upper 16 bits of the SPI in the ESP header. In the third embodiment, the fragment information is saved in the padding.

A first fragmented packet before the IPsec process illustrated in FIG. 18A is the same as the first fragmented packet before the IPsec process in the second embodiment illustrated in FIG. 14.

FIG. 18B illustrates a packet obtained by saving the fragment information prior to the IPsec process performed on the first fragmented packet in FIG. 18A. In the third embodiment, the fragment information “{flags, Fragment Offset}, flags (MF)=1 and Fragment Offset=0×0” that has been set in an IP header 1901 in FIG. 18A is saved in a padding portion 701 inserted subsequent to payload data as illustrated in a portion 701 of FIG. 18A. The fragment information “{flags, Fragment Offset}” set in the IP header 1901 is cleared and becomes “flags (MF)=0 and Fragment Offset=0×0” as illustrated in a portion 702 in FIG. 18A. A value of a Next Protocol field in the IP header 1901 becomes a value “0×32” that indicates ESP encryption. The above description is a process of Operation S203 illustrated in FIG. 13. FIG. 18C illustrates a packet obtained by performing the IPsec process on the first fragmented packet in which the fragment information in FIG. 18B has been saved.

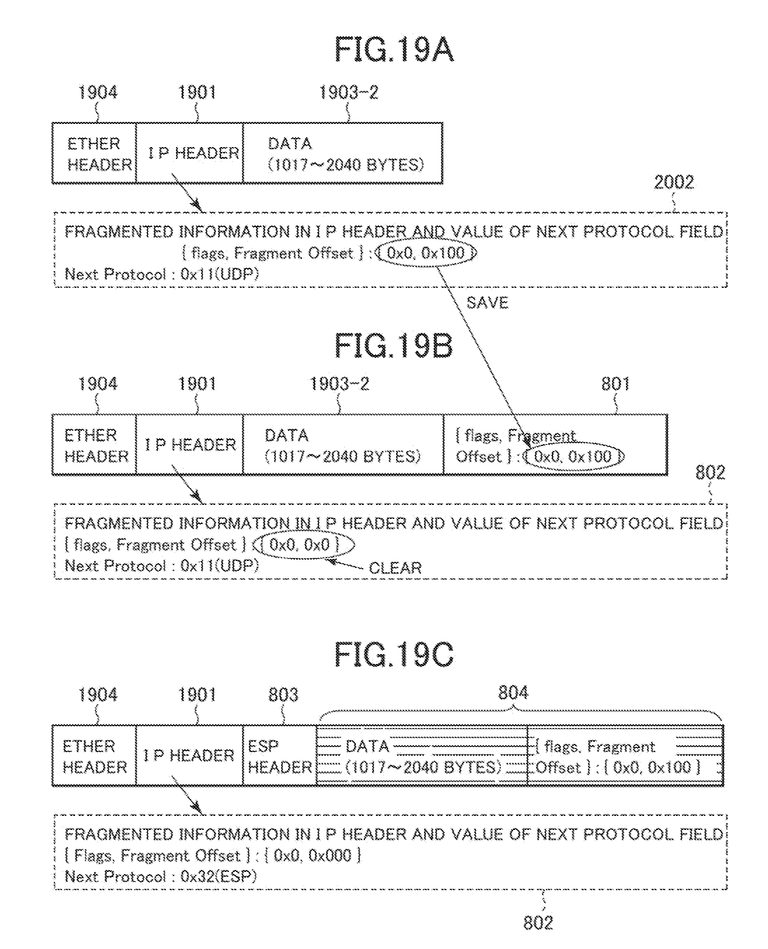

A data portion including a UDP header 1902, divided data 1903-1, and a padding portion 701 in FIG. 18B are encrypted and are stored in a data portion 704 in FIG. 18C, and the ESP header 703 is attached to the head of the data portion 704. The above description is a process of Operation S202 illustrated in FIG. 13. A second fragmented packet before the IPsec process illustrated in FIG. 19A is the same as the second fragmented packet before the IPsec process in the second embodiment illustrated in FIG. 15A.

FIG. 19B illustrates a packet obtained by saving the fragment information before the IPsec process of the second fragmented packet illustrated in FIG. 19A. In the same manner as FIG. 18B, the fragment information “{flags, Fragment Offset}, flags (MF)=0 and Fragment Offset=0×100” that has been set in the IP header 1901 in FIG. 19A is saved in a padding portion 801 inserted subsequent to the payload data as illustrated in a portion 801 in FIG. 19A. The fragment information “{flags, Fragment Offset}” set in the IP header 1901 is cleared and becomes “flags (MF)=0 and Fragment Offset=0×0” as illustrated in a portion 802 in FIG. 19B. The value of the Next Protocol field in the IP header 1901 becomes the value “0×32” that indicates the ESP encryption. The above description is the process of Operation S203 illustrated in FIG. 13. FIG. 19C illustrates a packet obtained by performing the IPsec process on the second fragmented packet in which the fragment information in FIG. 19B has been saved.

A data portion including divided data 1903-2 and a padding portion 801 in FIG. 19B are encrypted and are stored in the data portion 804 in FIG. 19C, and an ESP header 803 is attached to the head of a data portion 804. The above description is the process of Operation S202 illustrated in FIG. 13. The padding portion 801 is inserted subsequent to the payload data in the ESP format illustrated in FIG. 16A. Since a unit of process is determined by an encryption algorithm, the payload data may be adjusted such that the payload data is correctly associated with the unit. Data is attached so as to correctly associate the payload data with the unit. The attached data is the padding. The number of bytes in the attached data is set to a padding length in FIG. 16A.

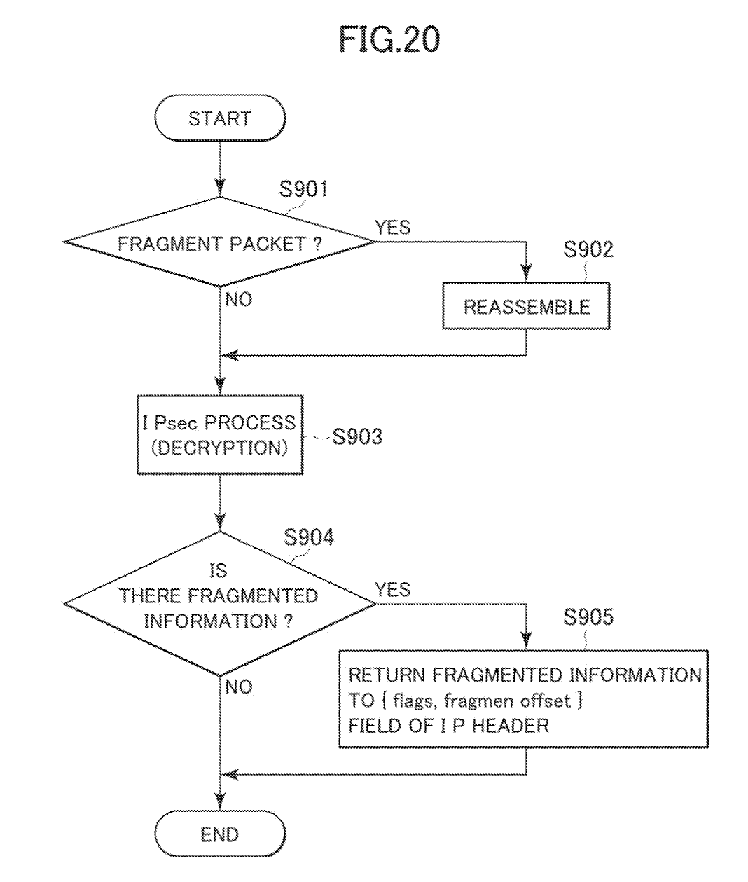

In the third embodiment, FIG. 20 illustrates an operation of an IPsec decryption process performed by a computer (router device, BITW device, or terminal device) in FIG. 12.

For example, it is determined whether or not a packet received via a network connection device 104 from a WAN in FIG. 12 is the fragmented packet (Operation S901). If the received packet is the fragmented packet, the received packet is determined to be the packet on which a sender performs a fragmentation process after the IPsec process, and a reassembling process is performed (Operation S902).

If it is determined that the received packet is not the fragmented packet or subsequent to the reassembling process, the IPsec process (decryption) is performed and an original packet before the encryption is picked up (Operation S903).

It is determined whether or not the fragment information is stored in the padding portion (see the portion 701 in FIG. 18B or the portion 801 in FIG. 19B) following the payload data of the decrypted packet (operation S904).

If the fragment information is stored, the decrypted packet is determined to be the fragmented packet. The fragment information is returned to a fragment information field of the IP header in the decrypted packet (see a portion 2001 in FIG. 18A or a portion 2002 in FIG. 19A) (Operation S905).

The packet before encryption obtained in the third embodiment is output to a LAN from the network connection device 104 in FIG. 12. If the output packet is the fragmented packet, the terminal device at a subsequent stage performs the reassembling process.

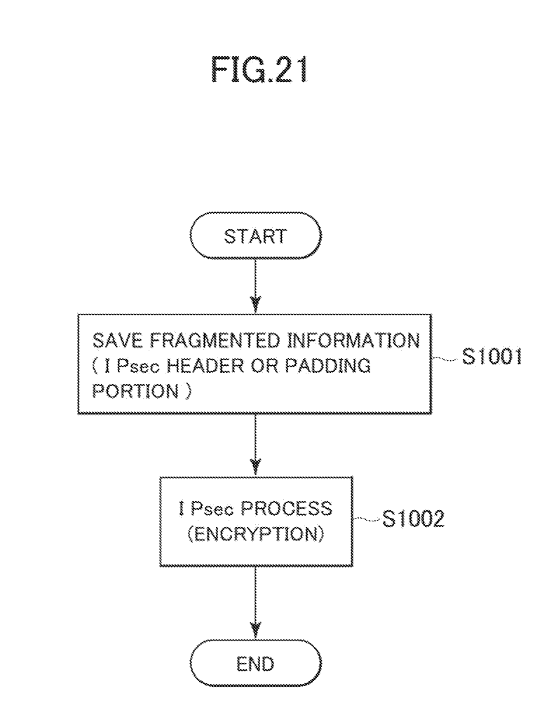

FIG. 21 illustrates a fourth embodiment. In the fourth embodiment, a determination on whether or not a received packet is a fragmented packet is not made and a piece of fragment information in an IP header is unconditionally saved in an ESP header in an IPsec encryption process.

In the fourth embodiment, a determination process on whether or not the received packet is the fragmented packet is not necessary. In consequence, the throughput of packet processes improves. FIG. 21 illustrates an operation of an IPsec encryption process performed by a computer (router, BITW device, or terminal device) in FIG. 12 in the fourth embodiment.

The fragment information (see a portion 2001 in FIG. 14A or a portion 2002 in FIG. 15A) in the IP header of the packet received via a network connection device 104 from a LAN in FIG. 12 is saved in upper 16 bits of an SPI field in the ESP header (see a portion 304 in FIG. 14 or a portion 404 in FIG. 15B) (Operation S1001).

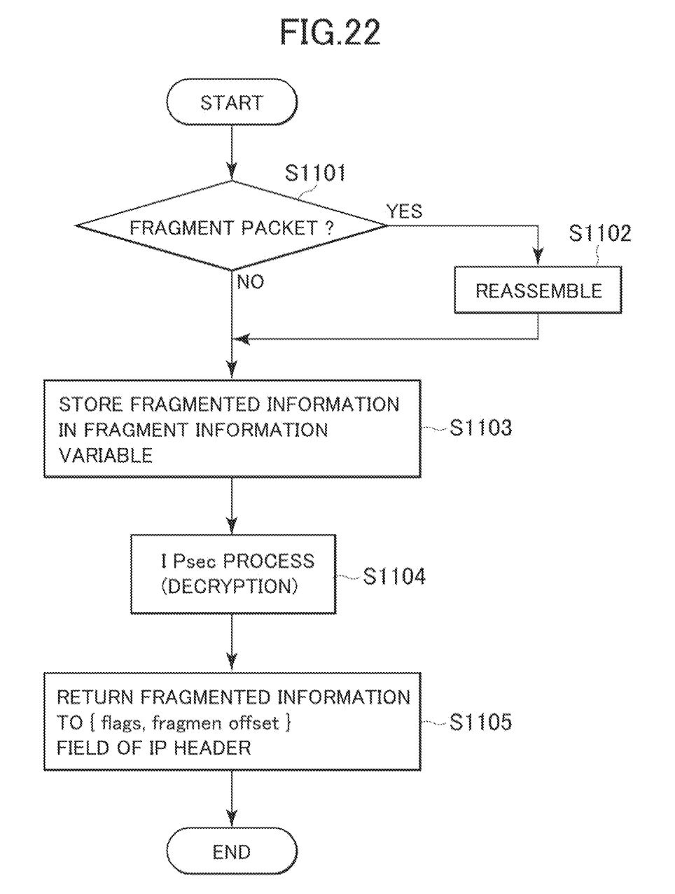

The IPsec process is performed (Operation S1002) and a generated IPsec packet is output to a WAN from the network connection device 104 in FIG. 12. FIG. 22 illustrates an operation of an IPsec decryption process performed by the computer (router device, BITW device, or terminal device) in FIG. 12 in the fourth embodiment.

For example, it is determined whether or not the packet received via the network connection device 104 from the WAN in FIG. 12 is the fragmented packet (Operation S1101). If the received packet is the fragmented packet, the received packet is determined to be the packet on which a sender performs a fragmentation process after the IPsec process, and a reassembling process is performed (Operation S1102).

If it is determined that the received packet is not the fragmented packet, or subsequent to the reassembling process, the fragment information stored in the upper 16 bits of the SPI field in the ESP header, that is, an IPsec header, is stored in a fragment information variable on a memory 102 in FIG. 12 (Operation S1103).

The IPsec process (decryption) is performed and an original packet before the encryption is picked up (Operation S1104). A value of the fragment information stored in a fragment information variable is returned to a fragment information field (see the portion 2001 in FIG. 14A and a portion 2002 in FIG. 15) in the IP header of the decrypted packet.

The packet before the encryption obtained in the fourth embodiment is output to the LAN from the network connection device 104 in FIG. 12. If the output packet is the fragmented packet, the terminal device at a subsequent stage performs the reassembling process.

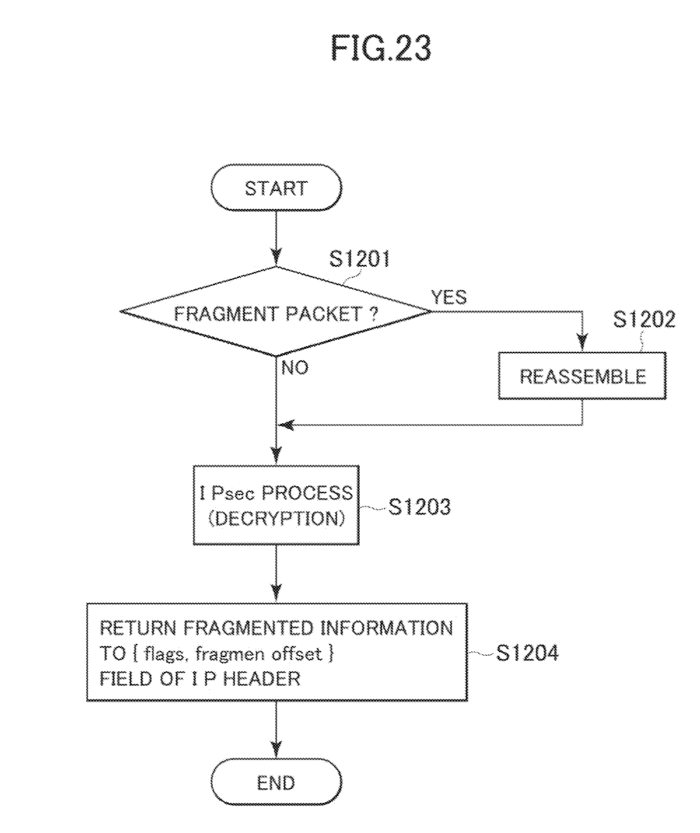

FIG. 23 illustrates a fifth embodiment. In the fifth embodiment, a save location is padding.

An operation of an IPsec encryption process performed by a computer (router device, BITW device, or terminal device) in FIG. 12 in the fifth embodiment is the same as that of the fourth embodiment in FIG. 21.

A fragment information saving process (Operation S1001) in the fifth embodiment is different from that in the fourth embodiment. A piece of fragment information is saved in upper 16 bits of an SPI in an ESP header in the fourth embodiment. On the other hand, the fragment information is saved in padding (see a portion 701 in FIG. 18B or a portion 801 in FIG. 19B) in the fifth embodiment.

FIG. 23 illustrates an operation of an IPsec decryption process performed by the computer (router device, BITW device, or terminal device) in FIG. 12 in the fifth embodiment. For example, it is determined whether or not a packet received via a network connection device 104 from a WAN in FIG. 12 is a fragmented packet (Operation S1201).

If the received packet is the fragmented packet, the received packet is determined to be the packet on which a sender performs a fragmentation process after an IPsec process, and a reassembling process is performed (Operation S1202).

If the received packet is not the fragmented packet, or subsequent to the reassembling process, the IPsec process (decryption) is performed and the original packet before the encryption is picked up (Operation S1203).

The fragment information is picked up from a padding portion following payload data of the decrypted packet (see a portion 701 in FIG. 18B or a portion 801 in FIG. 19B) and returned to a fragment information field (see a portion 2001 in FIG. 18A or a portion 2002 FIG. 19A) of an IP header in the decrypted packet (Operation S1204).

The packet before the encryption obtained in the fifth embodiment is output to a LAN from the network connection device 104 in FIG. 12. If the output packet is the fragmented packet, the terminal device at a subsequent stage performs the reassembling process.

In the second to fifth embodiments, an SPI field in the ESP header is used as the save location of the fragment information. However, a data format of an IP Authentication Header (AH header) illustrated in FIG. 16B has the SPI field and thus these embodiments may be applicable.

The second to fifth embodiments use the IPsec as a method of encrypting. However, these embodiments are not limited to the IPsec and are applicable to various methods in which encryption is performed without rewriting the fragment information of the IP header for the IP packet. Example embodiments of the present invention have now been described in accordance with the above advantages. It will be appreciated that these examples are merely illustrative of the invention. Many variations and modifications will be apparent to those skilled in the art.

1. A packet encryption method for encrypting an IP packet communicated based on an internet protocol, the method comprising:
saving fragment information included in an IP header in an area other than the IP header;
clearing the fragment information included in the IP header;
encrypting the IP packet in which the fragment information included in the IP header is cleared; and
outputting the encrypted IP packet.

2. The packet encryption method according to claim 1, further comprising:
saving the fragment information included in the IP header in a portion of an encryption header attached when encrypting.

3. The packet encryption method according to claim 1, further comprising:
saving the fragment information included in the IP header in a portion of a padding area attached when encrypting.

4. The packet encryption method according to claim 1, wherein the fragment information includes offset information that indicates a position from a head of original data of divided data and identification information that indicates whether the divided data is followed by subsequent data.

5. The packet encryption method according to claim 1, further comprising:
saving information regarding an area of the IP header in which the fragment information is stored in an area other than the IP header regardless of whether the IP packet is a divided packet or not.

6. The packet encryption method according to claim 1, further comprising:
saving the fragment information included in the IP header in one of an SPI field of an ESP header and an SPI field of an AH header.

7. A packet decryption method for decrypting an encrypted packet obtained by encrypting an IP packet including fragment information in a portion other than an IP header of an IP packet that is communicated based on an internet protocol, the packet decryption method comprising:
decrypting the encrypted packet;
returning the fragment information to the IP header of the decrypted IP packet; and
outputting the IP packet including the fragment information in the IP header.

8. The packet decryption method according to claim 7, further comprising:
returning the fragment information included in a portion of an encryption header attached when encrypting to the IP header of the decrypted IP packet.

9. The packet decryption method according to claim 7, further comprising:
returning the fragment information included in a portion of a padding area attached when encrypting to the IP header of the decrypted IP packet.

10. The packet decryption method according to claim 7, wherein the fragment information includes offset information which indicates a position from a head of original data of divided data and identification information which indicates whether the divided data is followed by subsequent data.

11. The packet decryption method according to claim 7, further comprising:
returning the fragment information to the IP header of the IP packet regardless of whether the decrypted IP packet is a divided packet or not.

12. The packet decryption method according to claim 7, further comprising:
returning the fragment information included in one of an SPI field of an ESP header and an SPI field of an AH header of the encrypted packet to the IP header of the decrypted IP packet.

13. A decryption device which decrypts an encrypted packet obtained by encrypting an IP packet including fragment information in a portion other than an IP header of an IP packet communicated based on an internet protocol, the decryption device comprising:
a decryption unit that decrypts the encrypted packet;
a setting unit that sets the fragment information in an IP header of the decrypted IP packet; and
an output unit that outputs the decrypted IP packet including the fragment information in the IP header.

14. The decryption device according to claim 13, wherein the setting unit sets the fragment information included in a portion of an encryption header attached when encrypting in the IP header of the decrypted IP packet.

15. The decryption device according to claim 13, wherein the setting unit sets the fragment information included in a portion of a padding area attached when encrypting in the IP header of the decrypted IP packet.

16. The decryption device according to claim 13, wherein the fragment information includes offset information that indicates a position from a head of original data of divided data and identification information that indicates whether the divided data is followed by subsequent data.

17. The decryption device according to claim 13, wherein the setting unit sets the fragment information in the IP header of the IP packet regardless of whether the decrypted IP packet is a divided packet or not.

18. The decryption device according to claim 13, wherein the setting unit sets the fragment information included in one of an SPI field of an ESP header and an SPI field of an AH header of the encrypted packet in the IP header of the decrypted IP packet.
